(19) United States
(12) Patent Application Publication
(10) Pub. No.: US 2022/0076190 A1
(43) Pub. Date: Mar. 10, 2022

(54) SMART TOTE

(71) Applicant: Radient Technologies Innovations Inc., Edmonton (CA)

(72) Inventors: Michael Cabigon, Edmonton (CA); Jim Seethram, Edmonton (CA); Steven Splinter, North Vancouver (CA); Denis Taschuk, Edmonton (CA)

(21) Appl. No.: 17/238,033

(22) Filed: Apr. 22, 2021

Related U.S. Application Data
(63) Continuation of application No. PCT/IB2019/058748, filed on Oct. 14, 2019.
(60) Provisional application No. 62/749,030, filed on Oct. 22, 2018.

(51) Int. Cl. G06Q 10/08; G06F 16/903

(52) U.S. Cl. CPC G06Q 10/083; G06F 16/90335

(57) ABSTRACT

The present disclosure is directed to systems and methods that monitor the quality or content included in cannabis products as those products are shipped from a source to a destination. Cannabis products consistent with the present disclosure include cannabis plant biomass, cannabis extracts, or products that contain cannabinoids. A controller at a shipping container may collect sensor data before, during, and after shipment of the cannabinoid containing product. The controller may perform analysis on sensed data or that sensed data may be sent to another computer for analysis. This sensor data may be used to identify the quality or content included of a cannabis product to see whether the quality or content of that product changed during shipment. The sensor data may also be compared to historical data when identifying preferred extraction processes or preferred settings or parameters to apply when an extraction process is performed.

### CROSS-REFERENCE TO RELATED APPLICATIONS

The present application is a continuation of PCT/IB2019/058748 filed Oct. 14, 2019 which claims the priority benefit of U.S. provisional patent application 62/749,030 filed Oct. 22, 2018, the disclosures of which are incorporated by reference herein.

### BACKGROUND OF THE INVENTION

### 1. Field of Invention

The present disclosure is generally related to active packaging or smart containers for shipping products. More specifically the present disclosure is directed to connecting and analyzing sensor data collected during transport of packaged cannabis-related products.

### 2. Description of the Related Art

As used herein, the terms “active packaging,” “intelligent packaging,” and “smart packaging” refer to packaging systems that may be used with foods, pharmaceuticals, and several other types of products that may be suitable for human consumption. Such packaging may tend to help extend shelf life, monitor freshness, display information on quality, improve safety, and improve convenience. The terms “intelligent packaging,” “active packaging,” and “smart packaging” are closely related. Active packaging usually means having active functions beyond the inert passive containment and protection of a product. Intelligent and smart packaging usually involve the ability to sense or measure an attribute of the product, the inner atmosphere of a package, or information associated with a shipping environment. This information can be communicated to user devices or can trigger active packaging functions. Depending on the working definitions, some traditional types of packaging might be considered as “active” or “intelligent/smart”. More often, the terms are used with new technologically advanced systems: microelectronics, computer applications, nanotechnology, etc. For many years, desiccants have been used to absorb excessive water vapor in a closed package. A desiccant is a hygroscopic substance usually in a porous pouch or sachet that is placed inside a sealed package. They have been used to reduce corrosion of machinery, to prevent oxidation of leads of electronic components, and to extend the shelf life of moisture sensitive foods and drugs. Active packaging is often designed to interact with the contents of the package. Thus, extra care may be needed for active or smart packages that contact food or human consumable materials. Companies that package foodstuffs commonly take extra care with some types of active packaging. For example, when the oxygen atmosphere in a package is reduced for extending shelf life, controls for anaerobic bacteria may be considered. Also, when a controlled atmosphere reduces the degradation of foodstuffs, individuals in the supply chain may need to retain a means of determining whether actual degradation of a consumable item has occurred.

Shock detectors have been available for many years. These are attached to the package or to the product in the package to determine if an excessive shock has been encountered. The mechanisms of these shock overload devices have been spring-mass systems, magnets, drops of red dye, and several others. Recently, digital shock and vibration data loggers have been available to more accurately record the shocks and vibrations of shipment. These are used to monitor critical shipments to determine if extra inspection and calibration is required. They are also used to monitor the types of shocks and vibrations encountered in transit for use in package testing in a laboratory. Data from smart packaging can be easily retrieved at a point of origin or a point of destination for the package, by scanning a label, RFID, NFC or a physical connection to the packaging. Developments in communications technology have allowed smart packages to communicate directly over cellular data, Wi-Fi, Satellite, GPS, or other wireless communication methods.

The supply chain of cannabis, cannabis extracts, and cannabis products presents additional challenges for smart packaging. As a controlled substance, security is paramount to successful transportation of cannabis as plant matter or products derived from cannabis plant matter may be stolen and diverted to the black market. As a biological product, environmental factors such as heat and humidity can compromise cannabis plant biomass. Cannabis plant biomass is susceptible to various forms of degradation that can be caused by mold growth, insect infestation, or cannabinoid breakdown. Factors that tend to increase the likelihood of such degradation include temperature and humidity. Since processors of cannabis plant matter biomass may be located hundreds or thousands of miles from a farm where cannabis plants are grown, plant matter can degrade in shipment when shipping conditions are not managed properly.

As a food or medicinal product, cannabis products may be susceptible to spoilage, as well as potential for the form factor to break down and or otherwise degrade (e.g. a cookie may crumble in transportation or cannabinoids included in extracts can degrade). Thus, there exists a need to not only secure cannabis packaging, but also continuously monitor cannabis packaging while in transport to avoid degradation of valuable materials. What are needed are new methods and apparatus that monitor and control environments associated with the shipping of cannabis plant biomass, the shipping of concentrates derived from processing cannabis plant biomass, or the shipping of cannabinoids containing products.

### SUMMARY OF THE CLAIMED INVENTION

The presently claimed invention relates to a method, a system, and a non-transitory computer readable storage medium that monitor a status (e.g., quality or content) of cannabis products as those products are shipped from a source to a destination. A method consistent with the present disclosure may identify an initial quality of a cannabinoid containing product that may be compared to a final quality of the cannabinoid containing product. The initial quality of the cannabinoid containing product may have been identified by analysis performed on a first set of sensor data that was received from sensors that sense factors associated with the cannabinoid containing product. Similarly, the final quality of the cannabinoid containing product may have been identified from a second set of sensor data that was received from the sensors that sense the factors associated with the cannabinoid containing product. After the first and the second set of sensor data have been collected and analyzed, an action may be initiated based on a difference between the final quality and the initial quality of the cannabinoid containing product. This quality difference may have been calculated by comparing factors associated with the first set of sensor data with factors associated with the second set of sensor data.

A system consistent with the present disclosure may include a plurality of sensors that monitor one or more factors of a cannabinoid containing product, a tote that receives the cannabinoid containing product, and a controller. The controller may receive a first set of sensor data from the sensors at a first point in time and may receive a second set of sensor data from the sensors at a second point in time. The first point in time may correspond to a time when a shipping tote was filled with the cannabinoid containing product and the second point in time may correspond to a time when the cannabinoid contacting product arrived at a destination. An initial quality of the cannabinoid containing product and a final quality of the cannabinoid containing product may be identified be performing an analysis on the factors, the first set of sensor data, and the second set of sensor data. The system may initiate an action based on a calculated difference between the final quality and the initial quality of the cannabinoid containing product.

When the presently claimed invention is implemented by a non-transitory computer readable storage medium, a processor that executes instructions out of the memory may perform the method. Here again the method may identify an initial quality of a cannabinoid containing product that may be compared to a final quality of the cannabinoid containing product. The initial quality of the cannabinoid containing product may have been identified by analysis performed on a first set of sensor data that was received from sensors that sense factors associated with the cannabinoid containing product. Similarly, the final quality of the cannabinoid containing product may have been identified from a second set of sensor data that was received from the sensors that sense the factors associated with the cannabinoid containing product. After the first and the second set of sensor data have been collected and analyzed, an action may be initiated based on a difference between the final quality and the initial quality of the cannabinoid containing product. This quality difference may have been calculated by comparing factors associated with the first set of sensor data with factors associated with the second set of sensor data.

### BRIEF DESCRIPTIONS OF THE DRAWINGS

FIG. 1 illustrates components of a system that may be used to collect and evaluate sensor data received before, during, and after a product has been shipped in a shipping container.

FIG. 2 illustrates a series of steps that may be performed by one or more processors implementing methods consistent with the present disclosure.

FIG. 3 illustrates steps that may be taken after a particular set of plant matter biomass has been extracted.

FIG. 4 illustrates a series of steps that may be performed when a concentrate is shipped back to a supplier after their plant matter biomass has been extracted.

FIG. 5 illustrates components of a control system of a container or tote within which plant matter biomass, extracts, or other cannabinoid containing products may be contained during shipment.

FIG. 6 illustrates an exemplary set of steps that may be performed by a control system consistent with the present disclosure.

### DETAILED DESCRIPTION OF THE DRAWINGS

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the examples set forth herein. The examples set forth herein are non-limiting examples and are merely examples among other possible examples.

The present disclosure is directed to systems and methods that monitor the quality or content included in cannabis products as those products are shipped from a source to a destination. Cannabis products consistent with the present disclosure include cannabis plant biomass, cannabis extracts, or products that contain cannabinoids. Cannabis products manufactured using cannabis extracts include, yet are not limited to a food, a capsule, a tincture, a rub or salve, or a substance that may be vaporized in a device that heats elements to temperatures that vaporizes cannabinoids. A controller at a shipping container may collect sensor data before, during, and after shipment of the cannabinoid containing product. The controller may perform analysis on sensed data or that sensed data may be sent to another computer for analysis. This sensor data may be used to identify the quality or content included of a cannabis product to see whether the quality or content of that product changed during shipment. The sensor data may also be compared to historical data when identifying preferred extraction processes or preferred settings or parameters to apply when an extraction process is performed.

The term cannabis or “cannabis biomass,” “cannabis plant matter biomass”, cannabis plant matter,” or simply “biomass” includes the Cannabis sativa plant and also variants thereof, including subspecies sativa, indica and ruderalis, cannabis cultivars, and cannabis chemovars (varieties characterised by chemical composition), which naturally contain different amounts of individual cannabinoids. These terms may also be assigned to cannabis plants that are the result of genetic crosses of one or more subspecies. The term cannabis is to be interpreted accordingly as encompassing plant material derived from one or more cannabis plants. The term “cannabis extract” or “extract” encompasses any extract of the cannabis biomass (also known as cannabis concentrate, cannabis oil, cannabis distillate, cannabinoid crystals, or cannabinoid isolates). A cannabis concentrate may be a product that has been extracted from cannabis plant biomass that may include a higher concentration of cannabinoids per unit mass than a concentration that exists in the cannabis plant biomass itself. Cannabis oil or distillate may be a concentrate that includes waxy substances or that may also include plant terpenes that were extracted from the cannabis plant biomass. As such, cannabis oils or cannabis distillates are not pure or substantially pure. Commonly such oils or distillates may contain somewhere between 50% and 80% cannabinoids per unit mass of the oil or distillate. Cannabinoid crystals, however, can contain nearly pure, greater than 95% cannabinoids per unit mass of the crystal. Cannabinoid isolates may only one type of cannabinoid that is nearly pure (greater than 95%). As such an isolate of cannabidiol (CBD) could contain 95% to 100% CBD.

The terms “cannabis product” or “product” may encompass any derivative product derived or produced from cannabis in any form suitable for any delivery method, including for example inhalation or ingestion. In certain instances, however, cannabis plant biomass may also be referred to as a “cannabis product” or a “product” that is or may be shipped in a shipping container or shipping tote consistent with the present disclosure.

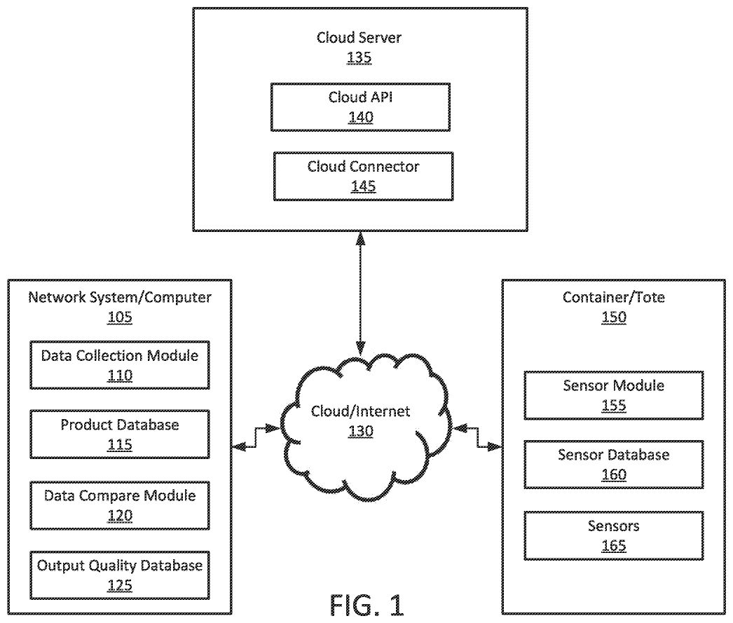

FIG. 1 illustrates components of a system that may be used to collect and evaluate sensor data received before, during, and after a cannabis biomass or derivative product has been shipped in a shipping container or tote. FIG. 1 includes network computer system 105, the cloud or Internet 130, a cloud server 135, and a container/tote 150. Network computer system 105 includes data collection module 110, product database 115, data compare module 120, and output quality database 125. Cloud server 135 includes cloud application program interface (API) 140 and cloud connector 145. Container/tote 150 is illustrated as including sensor module 155, sensor database 160, and sensors 165. Each of network computer system 105, cloud server 135, or tote 150 may include additional components not illustrated in FIG. 1. For example, each of these may include a processor that executes instructions out of a memory and may include one or more data communication interfaces that may allow network computer system 105, cloud server 135, and tote 150 to communicate with each other or with other computing devices.

In certain instances container/tote 150 may communicate with the network computer system 105 via the cloud or internet 130. Container 150 or other computing devices (e.g. a cell phone or mobile device) of users may connect to cloud server 135 via cloud connector 145 when downloading an application program. For example, a user device may communicate with cloud server when downloading a program application that may be API 140 of FIG. 1. In such instances, API 140 may be downloaded from an application store, such as the Apple APP store. API 140 may then expand the functionality of a user device to access features that might not be accessible without the installation of API 140 on a user device. As such, API 140 may extend or expand upon functionality native to a user device. Alternatively API 140 may be a web page interface that can be used to access information at cloud server 135. In certain instances, operations of cloud server 135 may be performed by network computer system 105. When preferred, communications between container/tote 150 and network computer system 105 may be passed through cloud server 135.

Cloud server 135 may allow user devices, third (3rd) party devices, or a tote controller to communicate with network computer system 105. For example, API 140 may allow user or 3rd party devices to access data stored at network computer system 105 directly or indirectly via cloud server 135 or a gateway. The Cloud Connector 145 may include program code executable to integrate applications with services provided by a cloud provider. In certain instances, a cloud provider may allow registered grower computers to access transportation or other information regarding the transport and/or processing of their personal plant matter biomass and extracts. In certain instances, API 140 may allow users to configure rules for accessing certain types of data.

In operation cloud server 135 may provide API 140 to container/tote 150 to configure a computing device at container/tote 150 to communicate with network server 105. A controller at tote 150 may begin collecting sensor data when a tote is loaded tote 150. This may include collecting sensor data when tote 150 is in transit to a destination. Sensor module 155 may be a set of program code executed by a processor at tote 150 that is used to also analyse received sensor data. Once the filling of tote 150 is initiated one or more sets of sensor data may be acquired and stored in sensor database 160. In certain instances, this sensed data may be sent to network computer system 105 via the cloud/internet in a raw format. Such data may be sent via a wireless communication interface that may be of any type of wireless interface known in the including, yet not limited to, a cellular interface, an 802.11 compatible interface, or a Bluetooth interface. A first set of sensor data may be used to identify an initial condition of the product stored in tote 150. Such evaluations may be performed by a controller at tote 150 or by a processor executing instructions out of a memory at network computing system 105. Data received from tote 150 may allow network computer system 105 to identify a quantity or quality of cannabis plant matter that is being sent for processing at a remote facility. Tote 150 may also collect data used to judge the quality of a cannabis product (e.g. concentrate or edible). At this time, a lot number or other identifying number may be assigned to the plant matter or product included in tote 150. This identifying number may be sent from tote 150 from network computer system 105 after which a printer at tote 150 could print a tag that can be placed on tote 150. Such tags could uniquely identify that tote XYZ presently contains cannabis plant matter identified by identifier 123, for example. Alternatively, a unique tag may be associated with tote 150 at the remote location. In such an instance, a user device or a computer at tote 150 may scan a unique tag and that tag may be physically connected to tote 150. In such instances, the tag may be a QR code, a sticker with imprinted information, or an electronic near field communication (NFC) tag known in the art. NFC tags used may be either an active or a passive NFC tag. When active NFC tags are used, they may be programmed with a unique identifier before or after a tag is connected to a tote. When passive NFC tags are used, a selected NFC tag may be scanned and data from that tag may be sent to network computer system 105. A particular tote could be associated with particular cannabis plant matter or cannabis product by network computer system 105 or by operations performed by a user when tote 150 is prepared for shipment. In either case, network computer system 105 may be able to store data that cross references a particular tote identifier with a particular set of cannabis plant matter or other product identifier. In other instances, tote 150 may be assigned a permanent identifying number that is associated with a new set of cannabis plant matter or cannabis product each time the tote is filled. Furthermore, an association of a tote identifier and a plant material identifier may be disassociated when the tote is emptied. As such, cannabis plant matter or cannabis products in a tote could be tracked in a way that does not require a new identifier to be attached to a tote each time a tote is loaded.

When tote 150 is being transported from a remote location to a processing facility, a controller at tote 150 may receive sensor data and store that sensor data in sensor database 160. In certain instances, sensor data received by this controller may not be sent to network computer system 105 until tote 150 reaches the processing facility. Alternatively, this sensor data may be wirelessly sent to network computer system 105 as it is moved toward a destination. This sensor data may be collected continuously or periodically. In yet other embodiments, data, even data that identifies an initial condition of the material, may not be transferred from sensor database 160 to the network computer system until tote 150 reaches a destination.

The sensor database 160 may store data collected from different sensors that collect data on environmental conditions inside or outside of tote 150. An analysis performed on this sensor data may allow for conditions of product included inside of tote 150 to be identified. Sensors included in tote 150 may be any sensor known in the art and these sensors may measure one or more of concentrations of certain gasses, a product weight, temperatures, the presence of mold, or an ambient humidity inside of tote 150. From this data, a condition of a biomass, an extract, or an edible product may be identified. Sensors may also sense a head space or a volume of empty space above plant material or other products included in tote 150. For example, a sonic or ultrasonic sensor may be used to sense or provide sensor data to determine a measure of empty space on top of tote 150 or to identify how full tote 150 is at a point in time. Such sensor data may be used to identify whether a portion of plant material or other materials have been removed from tote 150 before the tote reaches a destination. Alternatively, this sensor data may be used to identify that plant material in tote 150 has compressed over time. As such, the measuring an amount of free space on a top of tote 150 may help identify when theft has occurred or when plant matter is being compacted or crushed during shipment.

While FIG. 1 illustrates that tote 150 can communicate with network computer system via the cloud or internet, data acquired by the sensors may be sent to a user device via a first type of communication interface (e.g. 802.11 or Bluetooth) and may then be sent to network computer system via a second type of interface (e.g. a wired network at a remote site or via a cellular interface). Sensor data may also be sent to network computer system after tote 150 has been moved to a processing facility. In other embodiments, a data storage device at tote 150 may be removed from a computing device at tote 150 and placed in a reader that reads stored data and that provides that stored data to network computer system 105.

The data collection module 110 at network computer system 105 may be a set of program code that when executed by a processor causes collected data to be analyzed. In certain instances, the execution of the data collection module 110 program code may retrieve data from the product database 115 and output quality database 125 when comparing differences in product quality at different points in time. In such instances, the product database may store both initial quality data and final output quality data. Data compare module 120 may be a set of program code executable by a processor when the processor compares an initial an initial set of quality data with a final set of quality data. Before data is stored in a database, it may be organized into a table of data that cross-references different information. For example, a table of data may cross-reference a time, with sensor data acquired at that time, and with a product quality. A table entry could identify that at 2 pm Pacific Time on Sep. 20, 2019, that a temperature inside of tote 150 was 18 degrees C., and at this time the product quality was good. This quality data could also identify a cannabinoid content in a biomass or product. For example, a cannabinoid concentration of 18% by mass could be assigned to plant matter included in tote 150. This 18% number could identify that for every 100 grams of cannabis plant matter stored in tote 150 should contain 18 grams of tetrahydrocannabinol (THC), for example. The table of data could also include information from sensors located at various locations on the tote 150. After the network computer system 105 has received and organized a set of sensed data of a currently received lot of plant matter, data compare module 120 may compare this sensed data with historical data collected from previous shipments. This historical data may be used to make extraction yield projections or may be used to identify preferred extraction process parameters. Preferred extraction process parameters may include a type of solvent (e.g. ethanol or other) or a preferred measure of microwave energy to apply during an extraction, for example.

Container/tote 150 may include a set of hardware components that allows a control system to monitor conditions of a cannabis product (biomass, an extract, or other cannabis containing product) as that cannabis product is transported from a source to a destination. One or more sensors coupled to a processor that executes instructions out of a memory may be used as part of a system that monitors and analyzes how effective a transportation system is. Methods and apparatus consistent with the present disclosure allow for the collection of different sets of transportation data. These different sets of data may be correlated to factors that cause yield loss in an extraction process or that may damage products. Products such as extracts (e.g. distillates or isolates) or cannabinoid containing edibles (e.g. gummies, baked goods, or drinks) may each have a different set of preferred transportation constraints. Operation of the sensor module 155 program code of tote 150 may cause data to be transferred from the sensor database 160 of tote 150 to the network computer system 105, after which program code associated with the data collection module 110 may cause a processor to store received data in an appropriate database at system 105 of FIG. 1.

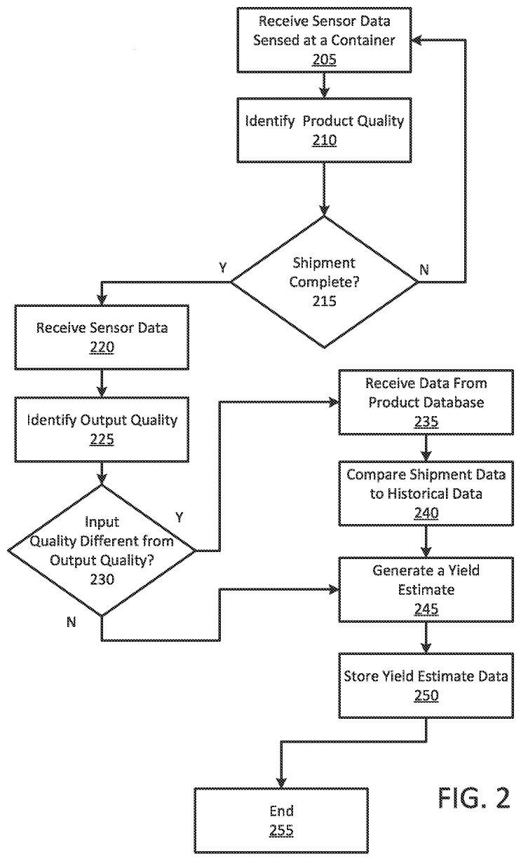

FIG. 2 illustrates a series of steps that may be performed by one or more processors implementing methods consistent with the present disclosure. FIG. 2 begins with step 205 that receives data that was sensed at a container/tote consistent with the present disclosure. Data received at step 205 may have been received from one or more sensors at a tote, such as tote 150 of FIG. 1. This receive data may include a set of initial data from which an initial condition of a cannabinoid containing product (e.g. plant matter biomass, an extract, or other products) is identified. Next step 210 of FIG. 2 identifies a product quality from the received sensor data. In certain instances step 205 and 210 may be performed by a processor at a tote that executes instructions consistent with the sensor module 155 of FIG. 1. Before storing collected data in a database, it may be organized into a tabular format that cross-references a sample time with information sensed from sensors inside of tote 150 and with data from sensors 165 that sense conditions on an outer portion or an inner portion of tote 150 over time. In other instances, this data may be provided to a computer system, such as network computer system 105 of FIG. 1 that may receive and analyze this sensor data.

Next determination step 215 of FIG. 2 may identify whether the shipment (is complete) has reached its destination, when no program flow may move back to step 205 where additional sensor data may be received. When determination step 215 identifies that the reached its destination, program flow may move to step 220 where additional sensor data is received. Sensor data collected during product shipment may be collected periodically, for example, sensor data could be collected every 30 minutes. When the product reaches a destination, sensor data may be used to identify a final condition or final quality of the shipped product at step 225 of FIG. 2. Differences in sensor data may be used to identify whether a product has degraded over time. For example, a mold sensor may identify that mold has increased in a set of plant matter biomass during shipment. Such a determination may cause an output quality assigned to a set of plant matter to be lower than the initial quality identified in step 210 of FIG. 2. Here again data from a currently received lot of cannabis plant material may be organized (e.g. tabulated) and then compared to historical data by execution of program code of data compare module 120 of FIG. 1. In such instances, this comparison may identify similarities or temperature changes over time. For example, comparing the current data table with a historical table to find similarities in temperature readings. This may allow the network computer system 105 of FIG. 1 to identify an output quality of the currently received plant matter and to allow an estimated concentrate yield to be calculated based on the output quality. An output quality may be compared to data in a database that stores historical plant matter data that has been collected over time. This historical data may include shipping conditions, quality indications, and resulting concentrate yields that were previously recorded. For example, in instances when shipping conditions of a current set of plant matter match shipping conditions of a previous set of plant matter, a quantity of an extract made from the current set of plant matter could be estimated based on a quantity of extract that was actually derived from the previously set of plant matter. Such comparisons could also identify that differences in input versus output qualities of the plant matter can negatively impact extraction yields. As such, differences in input versus output quality may be an important factor to consider when yield estimates are calculated.

Determination step 230 may identify whether there is a greater than a threshold level of quality difference between the initial quality and the output quality. When determination step 230 identifies that there product quality has not changed, program flow may move to step 245 that may estimate an extraction yield according to a baseline extraction efficiency that could have been set by historical precedence. In an instance when determination step sets a 3% change threshold in of an initial potency (e.g. concentration of cannabinoids) as compared to a final output potency and historical evidence suggests that such plant matter extractions are typically 96% efficient, then a yield estimate can be estimated in step 245 of FIG. 2 using this 96% efficiency number. In an example, 10 kilograms (kg) of cannabis plant matter having an initial potency of 17% THC and a final output potency of 16.5% a percentage difference calculation may be performed: (17−16.5)*17*100=2.94% difference, within the 3% threshold value. At this point the yield estimate generated in step would be 10 kg*0.165*0.96=1.584 kg of THC because the baseline efficiency number was used to estimate the yield.

When determination step 230 identifies that there is a quality difference, program flow may move to step 235 where data may be retrieved from a product database, such as the product database 115 of FIG. 1. In certain instances, the data retrieved from the product database may have been performed by network computer system 105 of FIG. 1. Next in step 240 data collected during the shipment of the product may be compared to historical data after which an extraction yield may be generated in step 245 of FIG. 2. This yield projection may be generated by first identifying a set of previously processed plant matter that had similar shipment and/or quality data. For example, the previous set of plant matter may have had a similar initial and final/output quality levels as the initial and output quality levels assigned to this current batch of plant matter or these two sets of plant matter may have degraded by a similar amount. Two different sets of shipment data may be considered similar when they have less than a threshold amount of difference, for example, when one quality level is within 5% of another quality level. Assume that for a first batch a first type of plant matter (Cannabis sativa) of a weight of 10 kilograms (kg) had an initial potency (concentration of cannabinoids or quality level) of 20% THC and had an output quality level of 17% THC and assume that a mass of THC included in a concentrate extracted from this plant matter had a total mass of 1.564 kg. A yield associated with extracting this first batch of Cannabis sativa could then be calculated according to the following set of calculations: a first calculation that identifies a total weight of THC included in the plant matter (plant mass*cannabinoid %)=10 kg*0.17=1.7 kg of THC; followed by a second calculation that determines processing efficiency: (total cannabinoid mass in plant biomass/total mass of cannabinoid extracted)=1.564 kg/1.7 kg=0.92 or 92%. Since the processing of the first batch of Cannabis sativa resulted in recovering 92% of the available 1.7 kg of THC included in the 10 kg of plant material, a second batch of Cannabis sativa that had similar shipping data could also likely have an extraction efficiency of 92%. In an instance when a second batch of Cannabis sativa had an initial quality of 19% THC and a final THC content of 16.5%, the initial THC content of these two batches is within 5% of each other ((20−19)/20=5%) and the final THC content of these two batches is also within 5% of each other ((17−16.5)/17=2.9%) a similarity level of both of these sets of transportation data may be considered to be within 5% indicating that as extraction efficiency of the second batch of cannabis plant should be approximately 92% efficient. At this point in time, a total cannabinoid yield of an extraction of the second batch of plant material may be estimated using the equation: (plant mass*cannabinoid %*extraction efficiency %)=10 kg*0.165*0.92=1.518 kg. As such, one or more sets of calculated differences may be used to generate an estimated yield. As in the example above, a set of two or more percentage difference equations or comparisons may be used to generate a yield estimate.

In another example, product data may comprise original potency (concentration of active cannabinoids in the biomass, extract, or product) and output quality data comprising potency. A difference in post-transportation quality of the product versus initial quality of the product may be reported to a user through an application. In such an instance, the original potency and final potency may be reported when determining whether a total percent change in cannabinoid content is within a threshold difference when generating an estimate. In instances where a similarity threshold is set at a 6% difference, where an initial potency of a current batch of cannabis indica was 18%, and the final potency was 17%, the total percent change in potency was: [[(original potency−output potency)/(original potency)]*100]=[(18−17)/(18)]*100=5.55%, this is within the threshold 6% value. If another batch of cannabis indica had a 95% extraction efficiency that was also within this 6% threshold difference, then the current batch of cannabis indica could be expected to have a 95% extraction efficiency. When the mass of the current batch of cannabis indica was 10 kg with a final potency 16.8%, then a total mass of cannabinoids derived from extracting this 10 kg of plant matter could be estimated by the equation: (plant mass*cannabinoid %*extraction efficiency %)=10 kg*0.168*0.95=1.596 kg.

After step 245, step 250 may store the yield estimate generated in step 245 of FIG. 2. Note that the yield estimate may vary depending on whether program flow moved from step 230 to step 245 or whether program flow moved from step 230 through step 235 and step 240 to step 245. After step 250 the program flow of FIG. 2 may end at step 255. Quality estimates may also be a calculated based on temperatures, highest temperature, lengths of time that a temperature was above a threshold level (e.g. 20 degrees C.), CO₂ levels, differences in CO₂ levels, or moisture/humidity sensed inside of a tote during shipment.

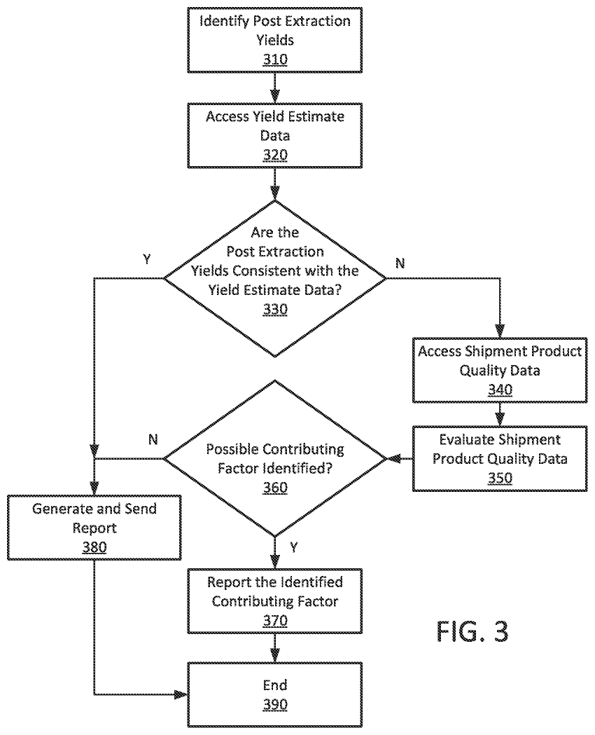

FIG. 3 illustrates steps that may be taken after a particular set of plant matter biomass has been extracted. Step 310 of FIG. 3 identifies post extraction yields. These yields could be identified based on analytical test results from any tester capable of determining cannabinoid concentration levels in concentrates. These test results may identify a concentration of cannabinoids in an extract, distillate or in an isolate. For example, a distillate could contain 60% cannabinoids (e.g. CBD, THC, CBN, or other cannabinoid) and 40% other materials or an isolate may include 99.5% of cannabinoids and 0.5% other materials. These percentages could be identified as a mass per total mass or per unit mass of the total set of material, as a percentage by volume, or by any standard relative measurement. Tests of these concentrates may be performed using a high performance liquid chromatograph (HPLC), a ultra-high performance liquid chromatograph (UHPLC), a gas chromatograph, an optical chromatograph, or any other type of analytical method.

Next in step 320 of FIG. 3, concentrate yield estimate data for this particular batch of cannabis plant matter biomass could be retrieved (accessed) from a database. Step 320 may also identify a total mass of cannabinoids derived from this particular set of plant matter biomass. The identification of the total mass of cannabinoids derived may be determined by measuring a mass or volume of concentrate and by performing calculations. For example, if a concentrate contained 60% of cannabinoids per unit mass of the concentrate and the concentrate weighed 2 kg, then the total mass of cannabinoids could be determined by multiplying the 2 kg by 0.60:2 kg*0.60=1.2 kg of cannabinoids. Determination step 330 could then identify whether the extraction yields were consistent with the yield estimate data. Such a consistency determination could be identified by checking to see if the total cannabinoids extracted were within a threshold distance from a yield expectation. Here again, such a threshold level could be identified using percentage difference calculations. For example, assume that the threshold was 10% from a yield estimate and the yield estimate indicated that this particular set of biomass should yield 1.3 kg of cannabinoids. At this point the 10% threshold value could be calculated by multiplying the 1.3 kg times 0.10 (1.3 kg*0.10=0.13 kg) and by adding and subtracting a result of this calculation from 1.3 kg: 1.3 kg+0.13=1.43 kg; 1.3 kg−0.13=1.17 kg yielding a high threshold 1.43 kg: and a low threshold of 1.235 kg. In this instance, a total cannabinoid yield between 1.17 kg and 1.43 kg would be consistent with the yield estimate. Since in this example, the total cannabinoid yield of 1.2 kg is within the threshold range of 1.17 kg-1.43 kg, then the yield estimate would be consistent with the actual extraction result.

In an instance where determination step 330 identifies that the post extraction results are consistent with the yield estimate, then program flow may move to step 380, where a report may be generated and sent to computing devices of management or of a customer representative, or both. After step 380 program flow may end in step 390 of FIG. 3. In an instance, where the post extraction results are not consistent with the yield estimate, program flow may move to step 340 where the shipment product quality data may be accessed. This shipment quality data may be retrieved from a database, such as the product database 110 of FIG. 1 or the quality output database 125 of FIG. 1. Next in step 350 of FIG. 3, the shipment quality data may be evaluated for any anomaly. If for example, the actual yield was less than the lower yield estimate threshold and the shipment data revealed that an internal temperature of a tote that contained the plant matter was elevated above other sets of otherwise ‘similar’ plant matter shipment data, then determination step 360 could identify that this elevated internal temperature could have been responsible for the yield loss. In an instance when a contributing factor is identified, it could be reported to management via an electronic communication (e.g. email or yield report document) in step 370 of FIG. 3. Step 370 of FIG. 3 could also store data for later reference or analysis. After step 370 program flow may end at step 390.

In instances when determination step 360 identifies that no contributing factor has been identified, program flow may move to step 380 where a report is generated and sent to management or to operations, engineering or quality management staff such that the shipment data may be reviewed by management or by a staff member. This may allow management or staff members to review anomalous data sets. Here again after step 380, program flow may end in step 390. It may also be possible for program flow to move from step 330 to step 340 when an actual yield result is greater than the high yield estimate data. In such an instance, possible contributing factors relating to why the yield exceeded expectations may be identified using steps 350 and 360. Here again, when no contributing factor were identified in step 360, program flow could move to step 380 and then to step 390, where program flow may end.

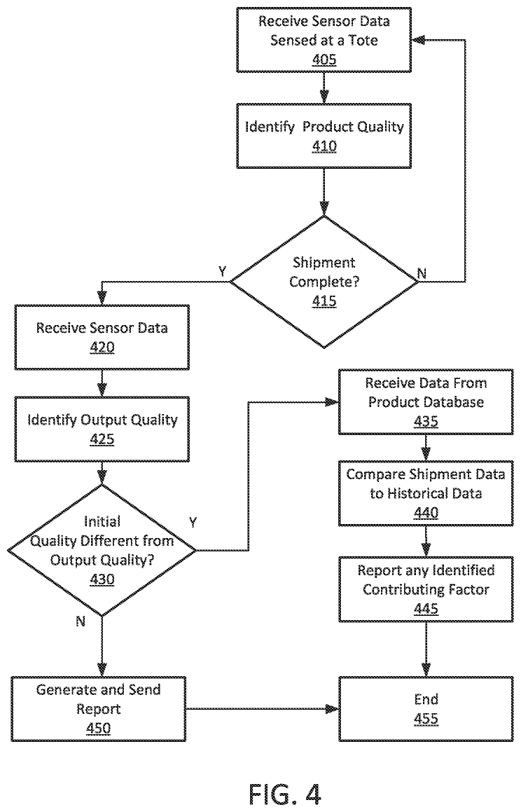

FIG. 4 illustrates a series of steps that may be performed when a concentrate is shipped back to a supplier after their plant matter biomass has been extracted. The steps of FIG. 4 may also be consistent with steps that may be performed when a product that contains cannabinoids (e.g. an edible cannabinoid containing product) is shipped to a customer. Step 405 of FIG. 4 is a step where sensor data sensed at a shipment tote may be received. Next, in step 410 a product quality may be identified. As or before the product leaves a processing facility, a first set of sensor data may be used to identify an initial quality of the product. This initial quality data may identify a purity, a concentration, or a total mass of one or more cannabinoids included in the product. Next, determination step 415 may identify whether the shipment has been completed, when no, program flow may move back to step 405, where additional sensor data is received. While in shipment, data may be collected from or by a controller at a tote, such as tote 150 of FIG. 1 as the product moves towards its destination.

Steps 405, 410, and 415 may be performed in a manner similar to steps 205, 210, and 215 of FIG. 2. Other steps included in FIG. 4 may also be implemented in ways similar to steps included in FIG. 2. Differences between content included in FIG. 2 versus FIG. 4 is that the steps of FIG. 2 are directed to tracking and forecasting yields based on shipping data. In contrast the steps of FIG. 4 are directed to tracking shipping data and to determining whether a product that is itself a concentrate or that was made using a concentrate has degraded or been damaged during shipment. As such, some of the steps performed in FIG. 4 may be performed by a tote and others may be performed by a network computer system, such as the tote 150 and the network computer system 105 of FIG. 1. Alternatively all of the steps performed in FIG. 4 could be implemented by a network computer system that receives data collected from controllers at shipping totes over time (before, during, or after the shipment of products).

When determination step 415 identifies that the shipment has been completed, program flow may move to step 420 where a set of final output shipping data may be received and then a final output quality of the product may be identified in step 425 of FIG. 4. The determination of product qualities over time may be identified using a set of initial shipment data, in-transit data, and final output shipping data. Here again factors measure may include a temperature, a gas, a mold, or a weight sensor. One or more optical sensors may be used to sense data that may be of a visual nature or a spectral nature. One of characteristic that may be observed is a clarity or intensity of color of an extract, another may be a level of CO₂, and another may be a distribution of color spectra associated with the product when a light is shined on or through the product. Changes in clarity, levels of CO₂, or change in a color spectral distribution may be indicative of a change in the product. For example, extracts high in the acidic form of THC may be transformed into a non-acidic form of THC (e.g. THC or Δ9 THC) via a process of decarboxylation that causes gaseous CO₂ to be emitted from the extract. Decarboxylation could be detected by an increase in CO₂ in a tote, a reduction of clarity or an increased darkness of the product, a shift in a color spectral distribution associated with the product, and a reduction of weight of the product. Such sensor data may also help quantify an amount decarboxylation that occurred during the shipment of the product as a mass of CO₂ emitted from the product during shipment would be a function of a change in a parts per million (ppm) of CO₂ in a sealed tote, a change in pressure in the tote, and a head space or empty space in the tote. Such gas data may be combined with weighing the product before and after shipment after extra CO₂ has been purged from an empty space in the tote. This purging of extra CO₂ could be accomplished by opening the tote and by ‘flushing’ the CO₂ out of the tote by circulating air through the tote. Temperature data may also be reviewed to identify temperatures or periods of time that a product was exposed to temperatures at or above one or more temperature threshold levels. This is because decarboxylation is known to be a factor of temperature, where decarboxylation will tend to increase as temperature increases. Sensor data could also be used to identify levels of specific cannabinoids included in the product and evaluation of that sensor data could determine whether those specific cannabinoids levels have changed during shipment. For example, reductions in a THC mass included in a product and in increase in a cannabinol (CBN) mass could indicate that a certain amount of THC degraded into CBN during shipment.

After step 425 of program flow may move to determination step 430 that may identify whether the initial quality is different from an output quality of the product. As reviewed above changes in sensor data may be used to identify whether decarboxylation has occurred or may determine whether a concentration of specific cannabinoid masses has changed during shipment. Changes in weights, masses of CO₂, changes in color/clarity, changes in spectral content, or changes in cannabinoid content included in the product may be indicative of differences in product quality. If any of these factors changed by more than a threshold amount, determination step 430 may identify that the final output quality is different from the initial quality. Such threshold levels may be identified using equations that compare masses of specific items (cannabinoid or gas concentrations) or may compare changes in percentage concentrations of a sample of the product. When a total mass of an item or when a relative percentage of an item changes greater than a threshold measure, determination step 430 may identify that the initial product quality is different from the final output quality and program flow may move from step 430 to step 435 of FIG. 4. Step 435 of FIG. 4 may the cause a processor at the network computer system 105 of FIG. 1 to retrieve data from a product database like product database 115 of FIG. 1. Next the information received from the product database may include historical data that is compared to identify any factor that may have contributed to the change in step 440 of FIG. 4. Such contributing factors may be included in a report that may be generated and sent to a management computing device in step 445, after which program flow may end in step 455.

In instances when determination step 430 identifies that the initial product quality is not different from the output quality, program flow may move from step 430 to step 450 of FIG. 4. Such a determination may be based on the metrics of the initial product quality not being greater that the threshold level. Step 450 may then generate and send a report to a computing device of management or of a customer informing management or the customer that the product did not change (significantly) during shipment. After step 450 program flow may end at step 455 of FIG. 4.

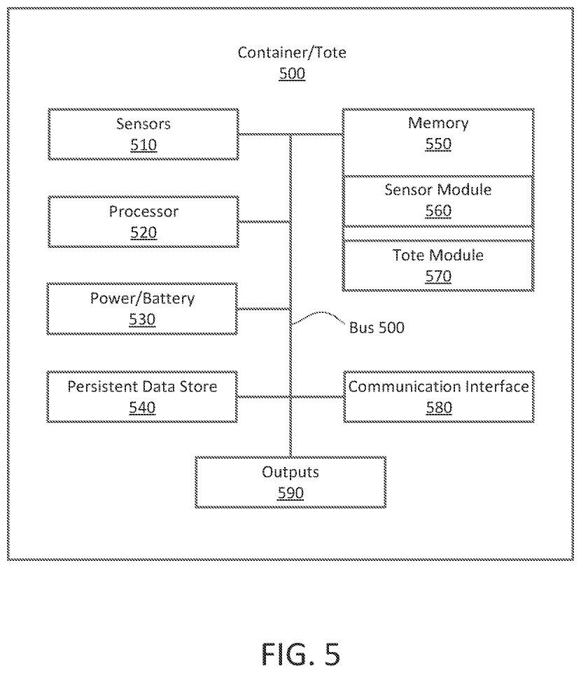

FIG. 5 illustrates components of a control system of a container or tote within which plant matter biomass, extracts, or other cannabinoid containing products may be contained during shipment. Container/tote 500 of FIG. 5 includes sensors 510, processor 520, power supply/battery 530, persistent data store 540, memory 550, communication interface 580, and outputs 590 that are communicatively coupled via bus 500. While the control system is identified as being attached to or included in tote 500, the elements of FIG. 5 may also be representative of a set of components of a network computer system, such as system 105 of FIG. 1. The memory 550 of FIG. 5 is also depicted as storing program code of program module 560 and tote module 570.

Sensors 510 may provide sensor data to processor 520 and processor 520 may execute instructions from the senor module 560 set of program code with evaluating and storing data in either memory 550 or in persistent data store 540. Data stored by the processor 520 may include sensor data or product quality data. Sensor module 560 program code may cause processor 520 to identify product quality after evaluating and received sensor data and when performing analysis or computations consistent with the present disclosure. Persistent data store 540 may be any non-volatile (NV) memory known in the art, typically a read/write form of memory such as Flash memory. Persistent data store 540 may also be or include other forms of persistent data storage, such as a disk drive, NV random access memory (RAM), or other persistent non-transitory computer readable storage medium.

Program code included in tote module 570 may cause processor 520 to retrieve (e.g. poll for) data from sensors 510 continuously or according to a pre-determined regimen. Sensors 510 may provide data directly to processor 520 digitally or analog sensor signals from sensors 510 may be provided to an analog to digital (A/D) converter before being received by processor 520. In certain instances, both analog and digital sensors may be used. Execution of instructions of the tote module 570 may also allow stored data or test results to be provided to a network computer system, such a system 105 of FIG. 1, via communication interface 580. As such communication interface 580 may be a WI-FI, a cellular, a ZigBee, Bluetooth wireless interface. Additionally or alternatively communication interfaces of tote 500 may be a wired communication interface (e.g. universal serial bus or Ethernet). Typically the power supply 530 of tote 500 will include a battery, yet tote 530 may also include an adapter that can connect power supply 530 to an source of alternating current (AC) power. As mentioned previously, the controller of FIG. 5 may also be representative of a network computer system. Typically such a network computer system will be attached to AC power source that provides electrical energy to power supply 530.

Outputs 590 may be used to control conditions with a shipping tote. For example, sensors 510 may sense one or more temperatures within tote 150 of FIG. 1 and when processor 520 identifies that a temperature has increased above a threshold level (e.g. 20° C.), processor 520 may turn on a cooler (e.g. a chiller, a refrigerator, or an air conditioner) by sending a command to the cooler to reduce the temperature on the inside of the tote to a temperature that is below the threshold level.

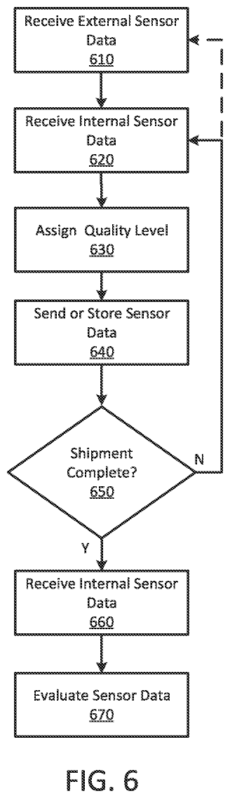

FIG. 6 illustrates an exemplary set of steps that may be performed by a control system consistent with the present disclosure. FIG. 6 begins with a step 610 that receives sensor data from sensors that are external to a shipping tote. The sensors external to the shipping tote may sense a temperature or a humidity of air that surrounds the shipping tote. These external sensors may include sensors that sense cannabinoid content or that sense a density of trichomes of cannabis plant matter or another product that is being introduced into an input of the shipping tote. Then in step 620 of FIG. 6, the control system may receive sensor data from sensors internal to the shipping tote. The sensors internal to the shipping tote may include a temperature sensor, a humidity sensor, a mold sensor, cannabinoid sensors, level sensors, or include density sensors. Trichomes in cannabis plant matter are hairy structures that create cannabinoids and color changes may indicate plant maturity and changes in cannabinoids included in specific trichomes.

Next, the cannabis plant matter or other product may be assigned a quality level in step 630 of FIG. 6. This quality level may be assigned based on a number of milligrams of a cannabinoid are included in an average gram of cannabis plant matter included in a container. As such, a quality level may be a percentage of cannabinoids included in a mass of the cannabis plant matter on average. Optical sensors may identify a density of trichomes in a unit area of plant matter. In one instance, images or video of plant matter may be acquired as cannabis plant matter is transferred into a tote. A processor executing instructions out of a memory may identify a number of trichomes per unit area (e.g square millimeters or centimeters) on leaf surfaces or per unit volume (e.g. cubic millimeter or centimeters) in flower material. Additional tests may be performed on leaf or flower material to identify a mass and an area of representative leaf samples or the mass and volume of representative flower samples. These additional tests may identify a mass of cannabinoids included in the leaf samples and in the flower samples. Testers that perform these analytical tests may be any method known in the art including, yet not limited to an optical tester, a high performance liquid chromatograph (HPLC), an ultra-high performance liquid chromatograph (UHPLC), a gas chromatograph (GC), a spectral tester, or other type of chromatography or mass spectrometry. An analysis of images of the various samples may allow for the processor to identify a number of trichomes included in an area of leaf material and a number of trichomes included in a volume of flower material. The processor may review image data when identifying or estimating a total area of plant matter and a total volume of plant matter that has been placed in the tote. If the plant matter was identified to include 1 mg of THC per square centimeter and the material was identified to have 30 mg of THC per cubic centimeter the processor could evaluate the received image data to estimate a total number of square area of leaf material and a total volume of flower material included in a tote. Assume that a tote with a volume of 5,000 cubic centimeters is filled with 4000 cubic centimeters (cm) of bud material and 1000 square centimeters of leaf material, then an estimate could be made of a total mass of THC included in the tote could be calculated: 4000 (cubic cm of bud material)*30 (mg/cubic cm)+1000 (square cm of leaf material)*1 (mg/square cm)=120,000 mg THC+1000 mg THC=121,000 mg of THC (or 121 g or 0.121 kg of THC). A total weight of combined material could be identified by weighing the material placed a tote. Furthermore, the processor could calculate an estimated weight of flower material and leaf material included in the tote. The processor could then execute instructions to identify whether the estimated weight was within a threshold percentage of the total weight. When the estimated weight was within a threshold distance of the actual weight (e.g. 3%), the processor could calculate a total mass of THC included in the tote. The estimate made by plant material weight calculations may be compared to the estimate made by area or volumetric calculations. Data relating to both of these estimates may be stored in a database and values of these estimates may be compared to each other to see if they are within a threshold distance of each other (e.g. within 2%). Such processes could help identify, manage, control, or update the ways in which estimates were made when an estimate derived from trichrome area/volume equations was not consistent with (e.g. a greater that 2% difference) with an estimate derived using mass equations.

In certain instances, the processor may review the image data to identify color and density of trichomes when identifying whether their color and density appeared consistent with the material samples discussed previously. The processor could receive an image of a flower when estimating a total number of cannabinoids included in that flower. This estimate could be based on a number of trichomes observed, test sample data, an estimated volume of the flower, color or contrast of the trichomes, and or an estimated mass of the flower. If the colors of trichomes in a flower are identified as not being fully developed, an total estimated mass of cannabinoids included in the flower may be de-rated by a derating factor. For example, when the flower is cloudy, white colored, or opaque, the flower may be considered high quality and fully developed. When the trichomes in the flower are clear (translucent), the flower may be considered immature and have a low quality. When the flower contains an even distribution of clear and cloudy trichomes, it may be associated with a medium quality level. Amber, orange, or brown colored trichomes may be associated with, yet another quality or classification that may indicate higher cannabinol (CBN) levels or a greater likelihood that consumption of these amber, orange, or brown colored trichomes will induce a “couch lock” effect. The “couch lock” effect is an effect reported by people that consume cannabis that makes them sleepy. This effect may be associated with cannabis that includes higher levels of CBN as CBN is believed act as a sedative to those that consume it. The colors, clarity, or opaqueness of cannabis plant trichomes described above are representative and are not intended to limit the scope of the present disclosure. Quality assignments based on colors, clarity, or opaqueness of cannabis plant trichomes may be updated over time as data is collected. For example, it may be found that when about 60% of the trichomes are opaque, 30% of the trichomes are amber, and when less than 10% of the trichomes are clear result in a better quality extract for a given extraction process or set of extraction parameters. Furthermore, any color spectra of plant trichomes may be identified as providing a better quality extract or an improved extraction efficiency (increased yield) for a given extraction process over time. As such, methods consistent with the present disclosure allow an extractor to learn how to identify preferred materials and how to set process parameters to perform more efficient extractions. Densities of trichomes may also be identified by a sonic or ultrasonic sensor that senses density by identifying a measure of sonic or ultrasonic energy that has been absorbed by or reflected by samples of plant matter.

After the cannabis plant matter or product has been assigned an initial quality level in step 630 of FIG. 5, that quality level and potentially the image or sensor data may be stored in a database in step 640 or may be transmitted to an external computing device, such as network computer system 105 of FIG. 1. Determination step 650 may then identify whether the shipment of the plant matter or product has completed. When no, program flow may move back to step 620 of FIG. 6 where additional interior sensor data is received. Alternatively program flow may move from determination step 650 to step 610 when the shipment is not complete. When the shipment is complete, program flow may move from step 660 to step 670, where a final set of internal sensor data is received. After step 660, step 670 of FIG. 6 may evaluate the sensor data received in step 660. This evaluation may compare beginning and ending quality metrics, or may evaluate all of the sensor data collected before, during, and after shipment of the plant material or product to a destination.

Changes in quality data, for example, trichrome color or opaqueness may be identified as a factor that could change the quality or content included in an extract after an extraction process has been performed. Changes in trichrome color to include more amber or more brown trichomes may indicate that THC has degraded into CBN. An amount of degradation could be identified by identifying from image data or spectral analysis a total percentage of all trichomes that changed color over time. For example, if 50% of trichomes changed from having an opaque white color to having an amber or brown color, a total mass of CBN in the plant matter may be estimated to have increased by 50%.

The components contained in a computer system of the present disclosure may be consistent with those typically found in computer systems that may be suitable for use with embodiments of the present invention. Thus, the computer systems discussed in the present disclosure may be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims.

What is claimed is:

1. A method for monitoring shipment of a cannabis product, the method comprising:
receiving a first set of sensor data at a first point in time from one or more sensors that monitor one or more factors of the cannabis product, each of the sensors located at a different location on a container holding the cannabis product in a current shipment;
identifying an initial status of the cannabis product based on the one or more factors indicated by the first set of sensor data;
receiving a second set of sensor data at a second point in time from the sensors;
identifying a second status of the cannabis product based on the one or more factors indicated by the second set of sensor data; and
initiating an action based on a comparison of the first status and the second status of the cannabis product, the action initiated including generating an extraction yield estimate regarding a total number of cannabinoids projected to be included in the cannabis product.

2. The method of claim 1, wherein the comparison indicates a difference between the first status and the second status, and further comprising:
identifying that the difference meets a difference threshold level;
retrieving from a database at least one data set regarding a previous shipment of cannabis product, the retrieved data set including a first status and a second status of the previous shipment; and
matching the at least one data set to the first status and the second status of the current shipment based on the first status and the second status of the previous shipment within a predefined correspondence threshold range.

3. The method of claim 2, wherein generating the extraction yield estimate is based on efficiency data in the data set regarding the previous shipment.

4. The method of claim 1, wherein the factors monitored by the sensors include one or more color levels exhibited by the cannabis product.

5. The method of claim 4, wherein the comparison of the first status and the second status indicates that a distribution of the color levels of the cannabis product has changed.

6. The method of claim 1, further comprising identifying a percentage of cannabinoids included in the current shipment of cannabis product, wherein initiating the action includes calculating a total mass of cannabinoids included in the current shipment of cannabis product.

7. The method of claim 1, wherein the factors monitored by the sensors include an ultrasonic level, and further comprising identifying a volume of empty space located in one or more different portions of the container based on the ultrasonic level, the empty space corresponding to a volume within the container that is not occupied by the cannabis containing product.

8. The method of claim 1, wherein the factors monitored by the sensors include a carbon dioxide (CO₂) level, and wherein the comparison between the first status and the second status indicated that the CO₂ level has increased between the first point in time and the second point in time.

9. The method of claim 8, wherein the factors monitored by the sensors include a pressure level, and wherein the comparison between the first status and the second status indicated that the pressure level increased between the first point in time and the second point in time, and further comprising identifying a mass of the cannabis product that changed from an acidic form to a non-acidic form between the first point in time and the second point in time.

10. The method of claim 1, wherein the factors monitored by the sensors include a temperature level inside the container.

11. The method of claim 10, further comprising:
identifying when the temperature level meets a predetermined temperature threshold level; and
activating a cooler that reduces the temperature level inside of the container based on the identification.

12. The method of claim 11, wherein the cooler is activated until the temperature level falls below the predetermined temperature threshold level.

13. A system for monitoring shipment of a cannabis product, the system comprising:
a container configured to hold a current shipment of the cannabis product;
one or more sensors each located at different locations on the container, wherein the sensors monitor one or more factors of the cannabis product; and
a controller associated with the container, wherein the controller:
receives a first set of sensor data at a first point in time from the sensors;
identifies an initial status of the cannabis product based on the one or more factors indicated by the first set of sensor data;
receives a second set of sensor data at a second point in time from the sensors;
identifies a second status of the cannabis product based on the one or more factors indicated by the second set of sensor data; and
initiates an action based on a comparison of the first status and the second status of the cannabis product, the action initiated by the controller including generating an extraction yield estimate regarding a total number of cannabinoids projected to be included in the cannabis product.

14. The system of claim 13, further comprising a remote computer that receives the first set of sensor data and the second set of sensor data sent over a communication network by the controller.

15. The system of claim 14, wherein the remote computer:
performs the comparison of the first status and the second status to identify a difference between the first status and the second status;
identifies that the difference meets a difference threshold level;
retrieves from a database at least one data set regarding a previous shipment of cannabinoid product, the retrieved data set including a first status and a second status of the previous shipment; and
matches the at least one data set to the first status and the second status of the current shipment based on the first status and the second status of the previous shipment within a predefined correspondence threshold range.

16. The system of claim 15, wherein the controller generates the extraction yield estimate based on efficiency data in the data set regarding the previous shipment.

17. The system of claim 13, wherein the factors monitored by the sensors include at least one of color level, ultrasonic level, CO₂ level, pressure level, and temperature level within the container.

18. The system of claim 17, further comprising a cooler that reduces the temperature level within the container, wherein the controller further:
identifies when the temperature level meets a predetermined temperature threshold level; and
activates the cooler based on the identification

19. The system of claim 18, wherein the cooler is activated until the temperature level falls below the predetermined temperature threshold level.

20. A non-transitory, computer-readable storage medium having embodied thereon a program executable by a processor for implementing a method for monitoring shipment of a cannabis product, the method comprising:
receiving a first set of sensor data at a first point in time from one or more sensors that monitor one or more factors of the cannabis product, each of the sensors located at a different location on a container holding the cannabinoid product in a current shipment;
identifying an initial status of the cannabis product based on the one or more factors indicated by the first set of sensor data;
receiving a second set of sensor data at a second point in time from the one or more sensors;
identifying a second status of the cannabis product based on the one or more factors indicated by the second set of sensor data; and
initiating an action based on a comparison of the first status and the second status of the cannabis product, the action initiated including generating an extraction yield estimate regarding a total number of cannabinoids projected to be included in the cannabis product.
